(19) United States
(12) Patent Application Publication
(10) Pub. No.: US 2011/0136662 A1
(43) Pub. Date: Jun. 9, 2011

(54) CATALYTIC SEEDING CONTROL METHOD

(76) Inventors: C.C. Chen, Taoyuan County (TW); Yu-Ting Cheng, Hsinchu City (TW); Lun-Hao Hsu, Taipei City (TW); Kai Rern, Taoyuan County (TW)

(21) Appl. No.: 12/722,001

(22) Filed: Mar. 11, 2010

(30) Foreign Application Priority Data
Dec. 4, 2009 (TW) 98141560

(51) Int. Cl. B01J 23/00

(52) U.S. Cl. 502/300

(57) ABSTRACT

A catalytic seeding control method is disclosed. A catalytic metal film is deposited on a substrate with a nonwettable inclined surface. The catalytic metal film is then melted to form metal droplets. The metal droplets roll along the nonwettable inclined surface and aggregate to form a singular catalytic seed on the bottom of the nonwettable inclined surface. Then, the location of the singular catalytic seed is precisely controlled. Also, the size of the catalytic seed is controlled by adjusting the size of the inclined surface and the thickness of the catalytic metal layer to grow a one-dimensional structure with specific localization and single well-aligned manipulated size. The structure is utilized for the integrated microelectronic device fabrication.

### BACKGROUND OF THE INVENTION

1. Field of the Invention

The present invention relates to catalytic seeding control methods. More specifically, the present invention discloses a simple and cost-effective catalytic seeding control method which accurately controls a size and a location of a catalytic metal seed during the fabrication processes. Besides, the catalytic metal seed is used to grow a nanostructure in one-dimensional direction.

2. Description of the Related Art

Recent progress in the synthesis and characterization of one-dimensional (1-D) materials has demonstrated potential nanoelectronic device fabrications using materials such as zinc oxide nanowire with negative electron affinity for room temperature field emission applications, carbon nanotube (CNT) with ballistic conductance for nanoscale field effect transistors, and tin oxide nanowire with surface state dependent conductance for chemical sensors.

So far, most of the 1-D materials can be mass produced by chemical vapor phase depositions with appropriate catalytic seeds whose size, composition, and morphology are critical to the resulting microstructure and physical property of the 1-D materials. Since the size and position of the catalytic seed would be the crucial factors for device fabrication using a typical “top-down” IC manufacturing approach, i.e. the synthetic control in forming a group of stand-alone and well-aligned 1-D material on a substrate for device fabrication, it is desirable to develop a feasible seeding control method to pave the way for integrated nanoelectronic device fabrication.

Several methods, such as Fe catalyst positioning on a Si pillar array, Ni catalytic seed locating in a non-lithographic anodized aluminum oxide (AAO) nanopore template, and electron-beam (EB) lithographically defining for seed size and location on a blank silicon substrate, etc., have been developed and proposed for the selective growth application of 1-D materials. To date, most of the approaches except the EB defining still cannot effectively achieve the required “precise” control in terms of the size, number, and location of catalytic seeds. However, even in the EB method, a special lab-made photoresist is required and approximate 10% of the catalyst can be activated for subsequent CNT growth. Furthermore, the EB technique is relatively time consuming for forming a tiny seed, which is around 10 nm.

### SUMMARY OF THE INVENTION

In view of the problems and shortcomings of the prior art, the present invention provides a catalytic seeding control method, so as to solve the afore-mentioned problems of the prior art.

An objective of the present invention is to provide a catalytic seeding control method, which uses a melted catalytic metal film to form several metal droplets on an arranged well hydrophobic inclined surface. Then, the metal droplets roll down along the surface and aggregate to form a single catalytic metal seed on the bottom of the hydrophobic inclined surface with a specific size. The catalytic metal seed is very helpful in growing a one-dimensional structure and show highly potentialities for integrated nano-electrical device fabrication in next generation of nano-electronic applications.

To achieve the abovementioned objectives, the present invention provides a catalytic seeding control method which comprises the following steps: forming a hydrophobic inclined surface on a substrate; depositing a catalytic metal film on the hydrophobic inclined surface; and melting the catalytic metal film to form a plurality of metal droplets. Then, the metal droplets roll along the hydrophobic inclined surface by utilizing gravitational force and aggregating to form a singular catalytic metal seed on the bottom of the hydrophobic inclined surface, wherein the singular catalytic metal seed is used to grow a one-dimensional nanostructure.

The present invention can grow a catalytic metal seed on a predetermined location, wherein a size of the catalytic metal seed depends on a thickness of the catalytic metal film and an area of the hydrophobic inclined surface. In other words, the present invention can not only grow the one-dimensional structure effectively but can also be applied to integrated nano-electrical device fabrication.

Following, the embodiments are described in detail in cooperation with the drawings to make easily understood the characteristics, technical contents and accomplishments of the present invention.

### BRIEF DESCRIPTION OF THE DRAWINGS

FIGS. 1A-1E are diagrams showing the steps for the catalytic seeding control method according to an embodiment of the present invention;

FIG. 2 is an Auger line spectrum of a singular Co seed according to an embodiment of the present invention;

FIG. 3 is a SEM micrograph of a singular CNT according to an embodiment of the present invention; and

FIG. 4A-4B are graphs for the bottom length of inverted pyramid nanostructure versus the size of agglomerated Co seed.

### DETAILED DESCRIPTION OF THE INVENTION

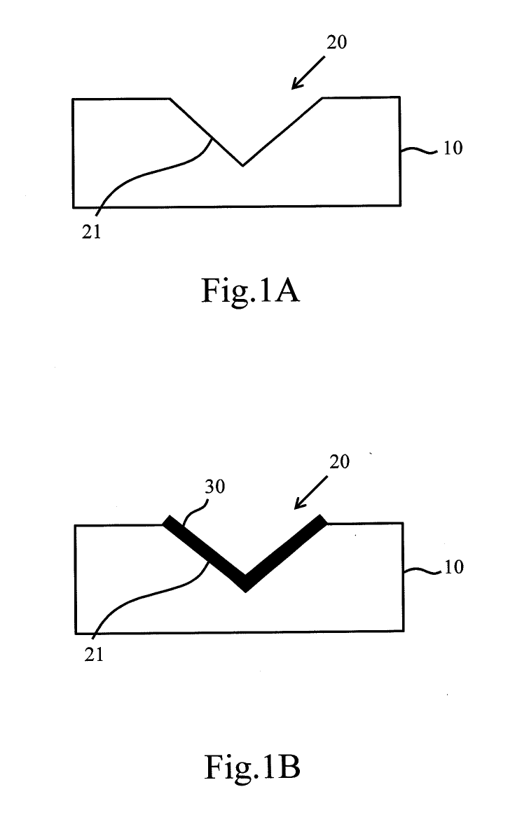

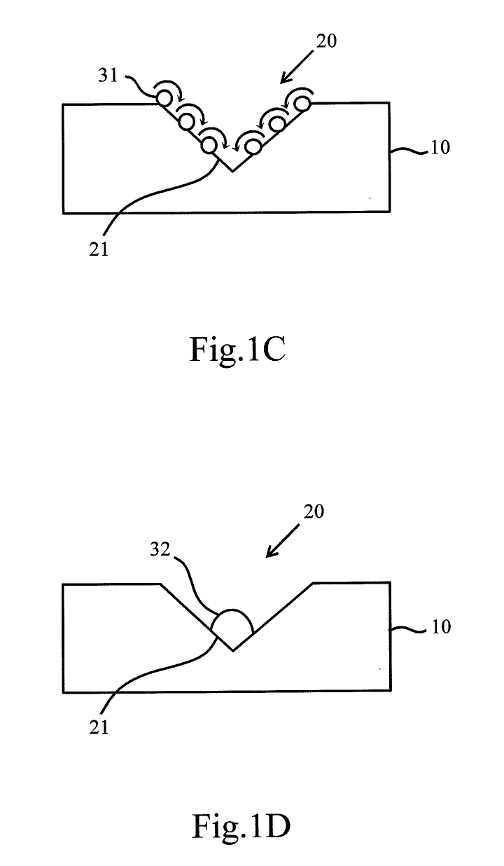

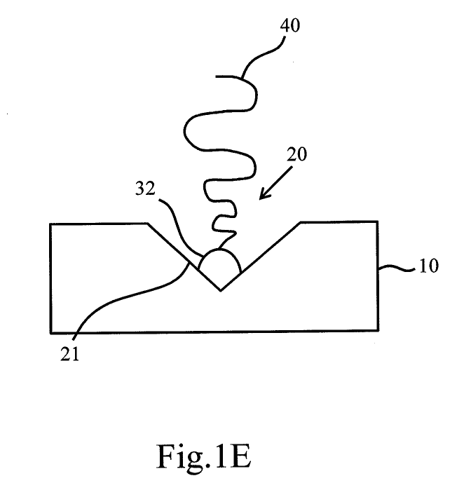

Refer to FIGS. 1A-1E, which describe a catalytic seeding control method according to an embodiment of the present invention. The catalytic seeding control method mainly comprises steps of:

Firstly, a 500 nm thick PECVD oxide is deposited on a (100) Si substrate 10, and then the PECVD oxide is coated with a 200 nm thick photoresist (not shown) lithographically patterned by e-beam followed by RIE oxide etching to form an opening. At the same time, the photoresist is removed. Next, as shown in FIG. 1A, the Si substrate 10 is implemented with an anisotropic etching process to form an inverted nano-pyramid structure 20 having a (111) hydrophobic inclined surface 21, wherein the anisotropic etching process requires KOH, TMAH, or EDP. The substrate can be a semiconductor substrate, a metal substrate, or an insulated substrate. The size of oxide opening which is related to the lower limit of the bottom length of the inverted pyramid structure 20 should be controlled as small as possible.

Then, as shown in FIG. 1B, the hydrophobic inclined surface 21 of the Si substrate 10 is sputtered by a layer of Co catalytic metal film 30.

As shown in FIG. 1C, the hydrophobic inclined surface 21 is followed by thermal anneal at high temperatures with a reasonable time frame (e.g. 1050° C., 10 mins) whereby the catalytic metal film 30 is melted to form a plurality of nm-sized Co droplets (metal droplets) 31, and then the Co droplets 31 roll along the hydrophobic inclined surface by utilizing gravitational force. According to the above-mentioned, as shown in FIG. 1D, the Co droplets 31 can aggregate to form at least one singular Co seed 32 (catalytic metal seed) on the bottom of the inverted nano-pyramid structure 20. Finally, the size of the catalytic metal seed 32 or the unnecessary oxide layer formed on the catalytic metal seed 32 are respectively reduced and removed by utilizing HF, BHF, or other metal oxide etchants. Therefore, the present invention is used to grow a one-dimensional nanostructure 40 such as a nanowire, a nanotube, or a nanorod. FIG. 1E shows a shape of the nanowire.

In the present invention, in order to form the catalytic metal seed with specific localization and single well-aligned manipulated size on the bottom of the inverted nano-pyramid structure, the physical relations between the size of the catalytic metal seed and the thickness of the catalytic metal film and the area of the hydrophobic inclined surface of the inverted nano-pyramid structure should be specified. The following is the detailed description based on the developing theory of the present invention.

The nm-sized droplet-like seed would just fall into the region where surface tension dominates gravitational force. Since Carter et al. have reported that a silicon surface is hydrophobic to molten Co, the shape of the nm-sized Co droplet on a horizontal surface can be assumed to be nearly spherical and the contact length of the droplet to silicon substrate, l, is

$$l ≅ {( \frac{ρ g}{γ} )}^{1 / 2} {R}^{2} , \qquad ( 1 )$$

where γ, R, ρ and g are the surface tension, radius and density of the metal droplet, and the acceleration of gravity, respectively. Thus, the onset of droplet rolling along the inclination with an angle of φ will be triggered as long as the following condition derived based on force equilibrium is satisfied:

$$R \leq \frac{1}{3 \sqrt{5}} \sqrt{\frac{γ}{ρ g}} \sqrt{\frac{sin 2 θ}{13 + 12 sin φ}} \qquad ( 2 )$$

where θ is the contact angle of the metal droplet on the hydrophobic silicon substrate. For instance, for the measured value of surface tension and contact angle of the molten Co on silicon substrate at 1514 k, which are 0.23 N/m and 121° respectively, the maximum radius of liquid droplet for rolling along the Si (111) plane)(φ=54.7°) is about 0.1 mm which is much larger than the size of the Co droplets formed on the surface of the inverted silicon pyramid, indicating that all Co droplets can roll down to the bottom of the pyramid for further aggregation. Meanwhile, for the case of a rolling droplet, the speed of the droplet moving along an inclination, v, can be calculated as follows:

$$v ∼ \frac{{γ}^{3 / 2} sin φ}{μ {R ( ρ g )}^{1 / 2}} \qquad ( 3 )$$

where μ is the viscosity of the metal droplet and can be estimated using the following equation:

$$μ ∼ 0.033 exp ( \frac{8.2 \times {10}^{5}}{RT} ) mPa \cdot s \qquad ( 4 )$$

Therefore, the rolling speed could be enhanced by slightly raising the reflowing temperature for a shorter reflow time in the process of the seed aggregation. In addition, the exceed surface Gibbs free energy of melted Co liquid on the inclination, Δgₛ, derived from the relation between the nominal radius and the deformation of drop-liked liquid on the inclination in the duration of nucleation can be further depicted by the original surface free energy on a plane times the modified function in terms of the receding and advancing angle:

$$Δ {g}_{s} = \frac{4}{3} π {R}^{2} γ [ f ( {θ}_{a} ) + f ( {θ}_{r} ) ] \qquad ( 5 )$$

The functions of θᵣ and θₐ mentioned above are calculated as follows:

$$f ( {θ}_{i} ) = \frac{( 2 + cos {θ}_{i} ) {( 1 - cos {θ}_{i} )}^{2}}{4} \qquad ( 6 )$$

where i represents a and r, which are advancing and receding angle, respectively. By introducing critical Gibbs free energy of nucleation, the size of the atomic cluster with maximum free energy can be determined as well as the minimum nominal radius of the seed-droplet on the inclination. Therefore, the region of radius of liquid droplet rolling along the inclination of an inverted silicon pyramid structure will be triggered while the following condition is satisfied:

$$\frac{\sqrt{2} {g}_{s}}{{g}_{v}} \sqrt{f ( {θ}_{a} ) + f ( {θ}_{r} )} \leq R \leq \frac{1}{3 \sqrt{5}} \sqrt{\frac{γ}{ρ g}} \sqrt{\frac{sin 2 θ}{13 + 12 sin φ}} \qquad ( 7 )$$

where gₛ and gᵥ, are the interface energy per area and Gibbs free energy per volume, respectively. The detail information regarding the formation, rolling, and agglomeration of a Co seed droplet in a patterned inverted silicon nano-pyramid structure is related to the thickness of the catalytic metal film and the area of the hydrophobic inclined surface of the inverted nano-pyramid structure.

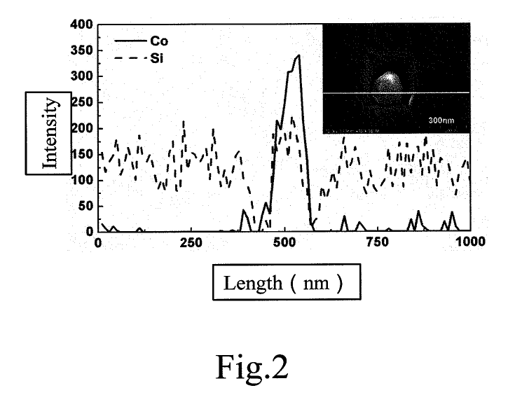

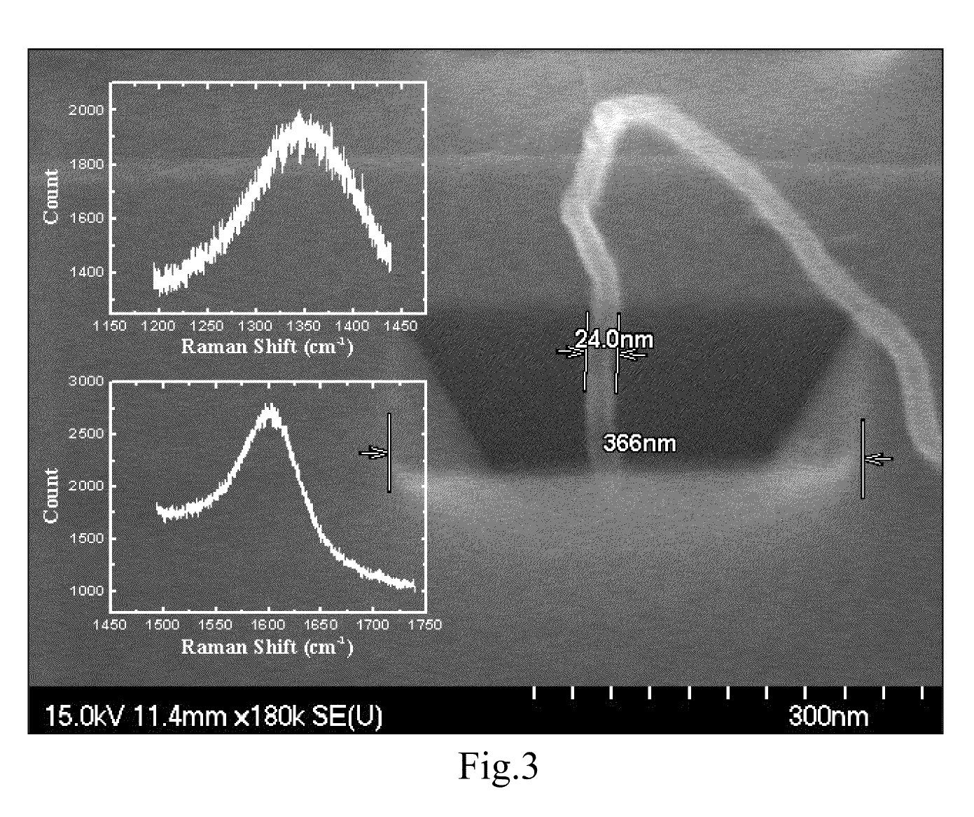

For verification of the presented invention, FIG. 2 reveals the Auger line scanning spectrum across a singular Co seed at the bottom of the inverted pyramid structure formed by the disclosed seeding control method reflowed with a 30 nm Co catalytic metal film. The detected 774 eV of Co and 1617 eV of Si signals shown in the spectrum as well as the SEM inset validate the seeding control method confirming a singular Co seed with the size of 150 nm in diameter located inside an inverted pyramid structure with a bottom length of 300 nm.

FIG. 3 shows SEM micrograph of a singular CNT grown from a Co seed formed by the disclosed seeding method which is reflowed with a 6 nm Co catalytic metal film. The CNT is grown under the conditions of a reduction treatment at 600° C. for 10 minutes with mixed gases of H₂ (250 ml/min) and Ar (250 ml/min). Then, C₂H₄ is introduced for another 2 minutes for CNT synthesis at 850° C. The individual flow rates for the Ar, H₂, and C₂H₄ are 375, 100, and 25 ml/min, respectively. The inset Raman spectrum of 1350 cm⁻¹ of D mode and 1598 cm⁻¹ of G mode peaks indicate the grown singular CNT is a multi-walled tube which could result from a large seed size. Nevertheless, the size of the catalytic metal seed can be further reduced for single-walled CNT synthesis applications via high temperature anneal in a pure Ar ambient to vaporize part of the catalytic metal seed.

In addition to the coalescence of seeds at the bottom of the inverted pyramid to achieve the unity and localization of catalytic seed, the seed size could be controlled by the thickness of the deposited Co and the size of the inverted pyramid. In an embodiment of the present invention, a variety of inverted pyramid structure whose bottom edge lengths ranging from 100 to 500 nm are fabricated on a (100) silicon substrate using KOH silicon etching technique. The silicon substrate is then deposited with either a 6 or 30 nm thick Co film for characterizing the correlation between the average size of Co seed, the size of the inverted pyramid structure, and the thickness of deposited Co film. The seed size is estimated by the law of mass conservation. It is assumed that all the coated Co film on the surface of inverted pyramid would melt, reflow, and agglomerate to form a singular seed at the bottom of the pyramid. Thus, the radius of seed coalescence (R) can be calculated as follows:

$$R = {[ \frac{3 \sqrt{3}}{4 π} \cdot t \cdot {L}^{2} ]}^{\frac{1}{3}} \qquad ( 8 )$$

where L and t are the bottom edge length of inverted pyramid structure and the thickness of deposited Co film, respectively.

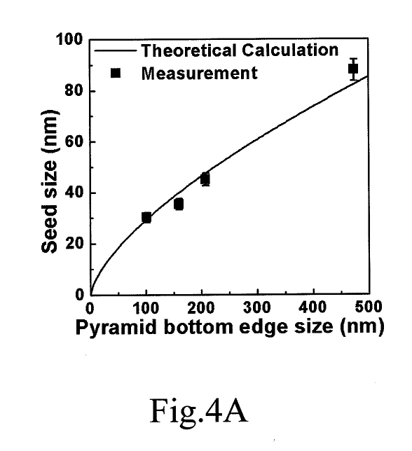

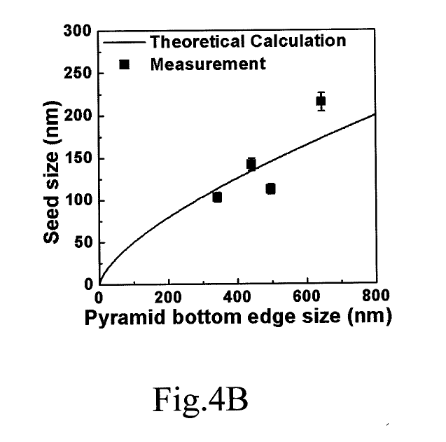

As shown in FIGS. 4A-4B showing the relationship between the bottom length of the inverted pyramid structure and the size of agglomerated Co seed formed inside. FIG. 4A and FIG. 4B represent the catalytic metal films with thicknesses of 6 nm and 30 nm, respectively. Meanwhile, the substrates are thermally annealed at 900 for 10 minutes. The calculation provides a good size prediction suggesting the seed size can be further reduced by reducing the thickness of deposited Co film and the size of pyramid.

In conclusion, the present invention discloses a method for controlling the localization and size of the catalytic metal seed successfully. Due to the fact that the metal droplets roll along the hydrophobic inclined surface, the metal droplets aggregate to form a singular seed on the bottom of the inclined surface. Rolling along an inclined surface is the key mechanism to the coalescence of seeds at the bottom. Experimental results confirm that by adjusting the thermal reflowing temperature and process time and specifying the deposited film thickness and the pyramid size, the size of the aggregated seed can be well determined. Therefore, a one-dimensional nanostructure can easily form on the seeds with specific localization and single well-aligned manipulated size by choosing an appropriate seed size. Furthermore, devices and circuits are fabricated by utilizing the one-dimensional nanostructure.

The embodiments described above are only to exemplify the present invention but not to limit the scope of the present invention. Therefore, any equivalent modification or variation according to the shape, structures, characteristics and spirit disclosed in the present invention is to be also included within the scope of the present invention.

What is claimed is:

1. A catalytic seeding control method comprising steps of:
forming a hydrophobic inclined surface on a substrate;
depositing a catalytic metal film on said hydrophobic inclined surface; and
melting said catalytic metal film to form a plurality of metal droplets, and then said metal droplets rolling along said hydrophobic inclined surface by utilizing gravitational force and aggregating to form a singular catalytic metal seed on a bottom of said hydrophobic inclined surface, wherein said singular catalytic metal seed, used to grow a one-dimensional nanostructure, has a radius depending on a thickness of said catalytic metal film and an area of said hydrophobic inclined surface.

2. The catalytic seeding control method of claim 1, wherein a following condition related to said hydrophobic inclined surface with an angle of φ is satisfied:
$$R \leq \frac{1}{3 \sqrt{5}} \sqrt{\frac{γ}{ρ g}} \sqrt{\frac{sin 2 θ}{13 + 12 sin φ}}$$
wherein θ is a contact angle of said metal droplets on said hydrophobic inclined surface; and γ, R, ρ and g are a surface tension, a radius and a density of said metal droplet, and an acceleration of gravity, respectively.

3. The catalytic seeding control method of claim 1, wherein a following condition related to said thickness of said catalytic metal film and said area of said hydrophobic inclined surface is satisfied:
$$\frac{\sqrt{2} {g}_{s}}{{g}_{v}} \sqrt{f ( {θ}_{a} ) + f ( {θ}_{r} )} \leq R \leq \frac{1}{3 \sqrt{5}} \sqrt{\frac{γ}{ρ g}} \sqrt{\frac{sin 2 θ}{13 + 12 sin φ}}$$
wherein γ, R, ρ and g are a surface tension, a radius and a density of said metal droplet, and an acceleration of gravity, respectively;
θ, gₛ, and gᵥ are a contact angle, interface energy per area, and Gibbs free energy per volume of said metal droplet on said hydrophobic inclined surface, respectively; and
a and r are advancing angle and receding angle of said metal droplet.

4. The catalytic seeding control method of claim 1, further comprising a step of etching to minimize a size of said catalytic metal seed by utilizing metal oxide etchant.

5. The catalytic seeding control method of claim 1, further comprising a step of vaporizing a part of said catalytic metal seed with high-temperature annealing whereby a size of said catalytic metal seed is further minimized.

6. The catalytic seeding control method of claim 1, wherein said substrate is selected from the group consisting of a semiconductor substrate, a metal substrate, and an insulated substrate.

7. The catalytic seeding control method of claim 1, wherein in said step of forming said hydrophobic inclined surface, an inverted nano-pyramid structure is fabricated on said substrate to form said hydrophobic inclined surface.

8. The catalytic seeding control method of claim 7, wherein said hydrophobic inclined surface is a (111) surface, and said substrate is a (100) silicon substrate.

9. The catalytic seeding control method of claim 7, wherein said inverted nano-pyramid structure is fabricated using a wet-etching method, which requires KOH, TMAH or EDP.

10. The catalytic seeding control method of claim 1, wherein said one-dimensional nanostructure is selected from the group consisting of a nanowire, a nanotube, and a nanorod.
